(19) United States
(12) Patent Application Publication
(10) Pub. No.: US 2005/0153265 A1
(43) Pub. Date: Jul. 14, 2005

(54) Entertainment device

(76) Inventor: Jordan Steven Kavana, Miami, FL (US)

Correspondence Address: AKERMAN SENTERFITT, P.O. BOX 3188, WEST PALM BEACH, FL, 33402-3188, US

(21) Appl. No.: 10/964,525

(22) Filed: Oct. 13, 2004

Related U.S. Application Data
(63) Continuation-in-part of application No. 10/335,021, filed on Dec. 31, 2002, now abandoned.

(51) Int. Cl. G09B 19/00

(52) U.S. Cl. 434/250

(57) ABSTRACT

An interactive entertainment device that may be capable of being used as a karaoke machine, a dance teaching aide, a combination of a karaoke machine and dance teaching aide, a competition device, and others. The interactive entertainment device may include a central processing unit, a dance mat having one or more sensors for receiving input from a user, a display device for displaying words of songs, one or more input devices, such as microphones, and one or more speakers for playing songs.

### FIELD OF THE INVENTION

This invention is directed generally to entertainment devices, and more particularly, to interactive entertainment devices such as karaoke and dance systems.

### BACKGROUND

Karaoke is a popular style of entertainment that enables people to sing famous songs while background instrumentals of the song are played. Karaoke enables people to relax and enjoy themselves at restaurants, bars, parties, and other locations or occasions while providing entertainment for their friends, family, and others who may be watching. Typically, karaoke machines include a music player, such as a compact disk (CD) player, coupled to one or more speakers. In addition, a microphone may be coupled to one or more speakers, and a display screen may be included to display the words to the songs to be sung by the singers. Karaoke machines allow singers to choose songs from numerous list of songs. In short, karaoke machines provide people with an interactive entertainment device.

Another form of entertainment is dancing. Dances have been taught over the years through one-on-one lessons, group instruction, video instruction, and other methods. Many aides have been developed to make the process of learning dance moves easier. Some of these aides include instructional booklets and the process of placing dance steps on dance floors to lead a dancer through the proper steps. While these steps provide a dancer with instruction as to where the dancer should place his or her next step, the aides do not alert dancers of the proper timing of steps or whether the dancers stepped in the proper locations.

### SUMMARY OF THE INVENTION

This invention relates to an interactive entertainment device. The device may be capable of using one or more of the following: a karaoke machine; a dance teaching aide; a combination of a karaoke machine and a dance teaching aide; a competition device; among other possible uses. The interactive entertainment device may include a central processing unit, a mat, one or more display devices, a memory device and an input device. The mat may be coupled to the central processing unit for teaching a user dance steps by receiving input from a user and transferring the input to the central processing unit. The mat may have one or more sensors positioned in the mat for receiving input from a user. The one or more display devices may be coupled to the central processing device for displaying song selections, for guiding a user through words of a song when used as a karaoke machine, to display scorecards, and other items. The memory device may be used for storing song lists, songs, scores, and other items may be coupled to the central processing unit. In one embodiment, the memory device may be a removable cartridge. In another embodiment, the memory device may be a CDG (compact disk+graphics) system. The input device may be a microphone for receiving input from a user.

The interactive entertainment device may be operated in one of numerous modes. For instance, the interactive entertainment device may be used as a karaoke machine by displaying songs on the display device, which may be a monitor, television screen, or other device. Songs may be chosen by a user and displayed on the display device. The interactive entertainment device guides a user through the Each word is highlighted when the word should be sung by the user.

In the dance mode, a user is given the option of choosing a difficulty level of the dance to be performed. The user may or may not be given the option of choosing the song to be played. After the user chooses one or more songs, the user may start the teaching aide by depressing a key. Once the song has begun, the display device displays arrows that indicate to the user where the user should place his or her feet. The mat receives the input from the user's feet and transmits the information to the central processing unit, which determines whether the user completed the step in proper timing. If the user made a correct step, the user is awarded one or more points. Otherwise, one or more points may be deducted from the user's score. The user dances until the song ends or the user runs out of points.

In the karaoke and dance combination mode, the interactive entertainment device combines the karaoke and dance mode to enhance a user's enjoyment of the device. The user may choose a song from a list of songs. The interactive entertainment device operates by displaying the words to the song on the display device and audibly playing the song except for the vocals. The display device also may display indicators, such as arrows, for guiding the user through the dance. The interactive entertainment device may or may not keep score.

In the competition mode, the interactive entertainment device enables two or more users to compete against each other in a dance competition. The central processing units of two mats are coupled together. The display device displays a screen having one side displaying information for a first user and another side displaying information for a second user. The users compete against each other by following the dance instructions on the screen and stepping in the appropriate place on the mats. The user with the higher score at the end of the song is the winner. If one user loses his or her points before the end of the song, the other user is able to continue dancing until that user either loses all of his or her points or the song is completed. The scores may be shown at the end of the song.

An advantage of this invention is that the interactive entertainment device enables a user to enjoy a single device that can function as a karaoke machine, a dance teaching aide, a karaoke and dance combination device, or a competition dancing device.

These and other features and advantages of the present invention will become apparent after review of the following drawings and detailed description of the disclosed embodiments.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of an embodiment of the interactive entertainment device of this invention.

FIG. 2 is mat usable in the interactive entertainment device shown in FIG. 1.

FIG. 3 is a perspective view of a portion of a central processing unit usable in the interactive entertainment device shown in FIG. 1.

FIG. 4 is an artistic rendition of an input device usable in the interactive entertainment device shown in FIG. 1.

FIG. 5 is a screen shot of a mode selection screen of this invention.

FIG. 6 is a screen shot of a song selection screen of this invention.

FIG. 7 is a screen shot of a typical karaoke screen of this invention.

FIG. 8 is a screen shot of a typical dance guide screen of this invention.

FIG. 9 is a screen shot of a typical competition screen of this invention.

### DETAILED DESCRIPTION OF THE INVENTION

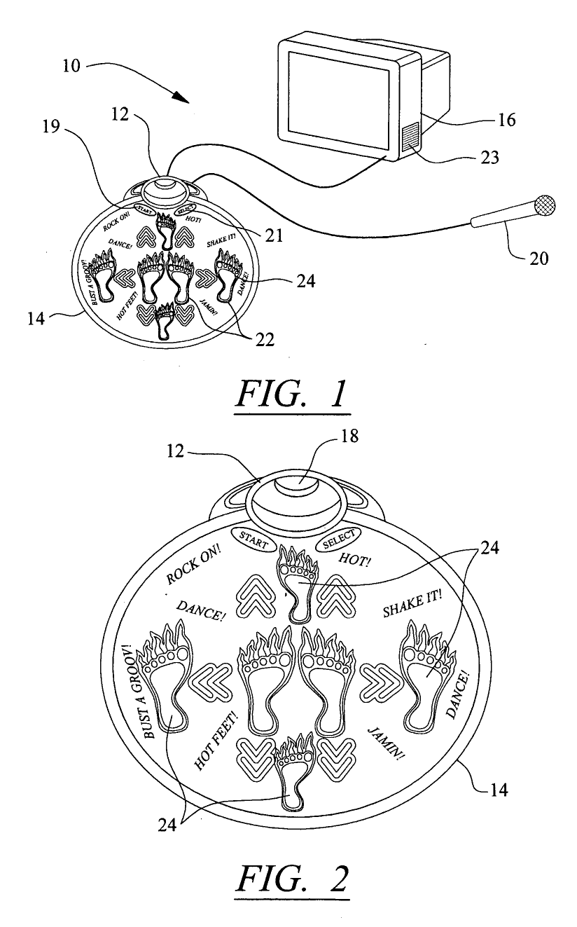

As shown in FIGS. 1 and 2, this invention is an entertainment device 10 that offers a user a choice of a variety of different play modes. Entertainment device 10 may operate in numerous modes, such as, but not limited to, a karaoke mode, a dance teaching mode, a karaoke and dance combination mode, a duet mode, or a competition mode. Each mode may use all or a portion of the equipment included in entertainment device 10. The modes may be changed at a user's discretion.

I. Components

Generally, entertainment device 10 includes a central processing unit 12 for controlling the operation of entertainment device 10. Central processing unit 12 may be coupled to numerous devices, such as, but not limited to a mat 14, a display device 16, a memory device 18, one or more input devices 20, and one or more speakers 23. Mat 14 includes one or more sensors 22 for receiving input from a user and for transferring the input to central processing unit 12. In one embodiment, four or more sensors are attached to mat 14 in a cross formation. Sensors 22 may be integrally formed in mat 14, coupled to an inside or outside surface of mat 14 using an adhesive or other material, or otherwise attached to mat 14. Sensors 22 may detect heat, pressure or other input item generated by a user. Mat 14 may also include a foot actuated on/off switch 19 and a mode switch 21 for selecting between various modes of the entertainment device. Mat 14 may have a top surface with an aesthetically pleasing decoration. In one embodiment, mat 14 may be decorated with numerous foot prints 24, as shown in FIGS. 1 and 2. Footprints 24 or other icon may be positioned on top of sensors 22 to guide a user to the location of sensors 22 within mat 22.

Entertainment device 10 includes one or more display devices 16 that enable a user to interact with central processing unit 12. Display device 16 may be, but is not limited to a monitor, a television set, or other electronic display device. Display device 16 may be coupled to central processing unit 12 using conventional audio/video (AV) connectors and cables, wireless communication technology, or other devices.

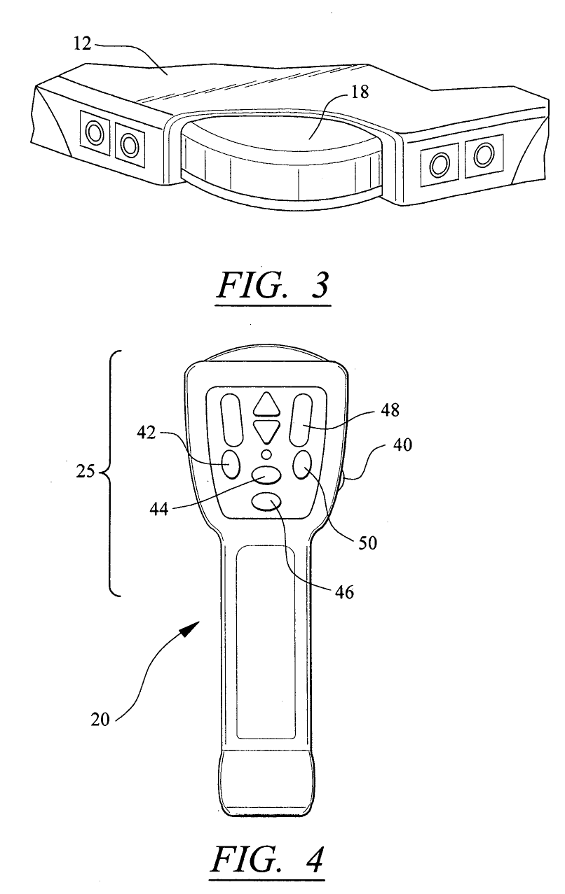

Central processing unit 12 is coupled to a memory device 18, as shown in FIG. 3, that provides central processing unit 12 with programs and other information. Memory device 18 may be included as a part of central processing unit 12. In one embodiment, memory device 18 is a removable cartridge. The removable cartridge may contain lists of songs, dance programs, records of the high scores for dances, and other information. In another embodiment, the memory device 18 may be a CDG (compact disk+graphics) system. The CDG may include music tracks, in addition to song lists, lyrics and graphics for display on the display device 16.

Entertainment device 10 may include one or more input devices 20, as shown in FIG. 4, that enable a user to communicate with central processing unit 12. In one embodiment, input device 20 is a microphone. Input device 20 may be coupled to central processing unit 12 using electrical wires, wireless technology, or through other devices. Input device 20 may also include controls 25 for controlling the operation of entertainment device 10. Controls 25 may include, but are not limited to, an on/off switch 40, a mode select switch 42, a volume button 44, an echo button 46, one or more tempo buttons 48, a start button 50, pitch control buttons, and others. In another embodiment, controls 25 are located on central processing unit 12 and may be operated by being contacted with a user's foot, toes, or other body part.

II. Operation of Entertainment Device

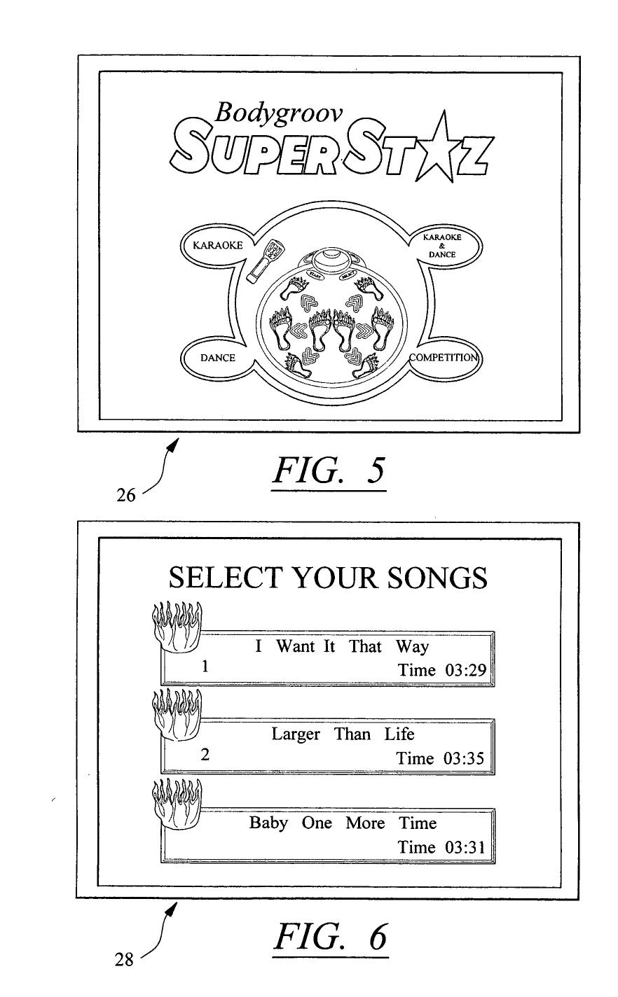

Entertainment device 10 may be operated by first coupling the device to a power source, such as, but not limited to, a conventional alternating current (AC) power source, such as a conventional wall outlet, a battery, which may or may not be rechargeable, or other power source. Entertainment device 10 may then be turned on using an on/off switch, which may be located on either input device 20 or on central processing unit 12. Central processing unit 12 then displays a mode selection screen 26, as shown in FIG. 5. Mode selection screen may include, but is not limited to, icons for a karaoke mode, a dance mode, a karaoke and dance mode, and a competition mode. A user may choose a mode by depressing a button on input device 20 or on mat 14. After a mode is chosen by a user, the modes operate as described below. The order of operation described below for each mode may vary. Each step may or may not occur in the order described.

A. Karaoke Mode

Entertainment device 10 may operate in a karaoke mode in which entertainment device 10 plays the instrumentals of a chosen song and guides a user through the song by displaying words of the song on a display device 16. Central processing unit 12 communicates with memory device 18 and displays a song selection screen 28, as shown in FIG. 6, on display device 16. A user may scroll through multiple screens containing lists of songs using controls 25 on input device 20, controls on central processing unit 12, or with other devices. In one embodiment, a user may scroll through the songs using keys that may be labeled “up” or “down” on input device 20. A song may be selected using a key labeled “select” 42. A user may select more than one song to be played in the order selected. In one embodiment, a user may select up to five or more songs to be played in successive order. The list of songs displayed on display device 16 may include song titles and the artists performing each song. In addition, the songs may be grouped into classifications, such as by song type.

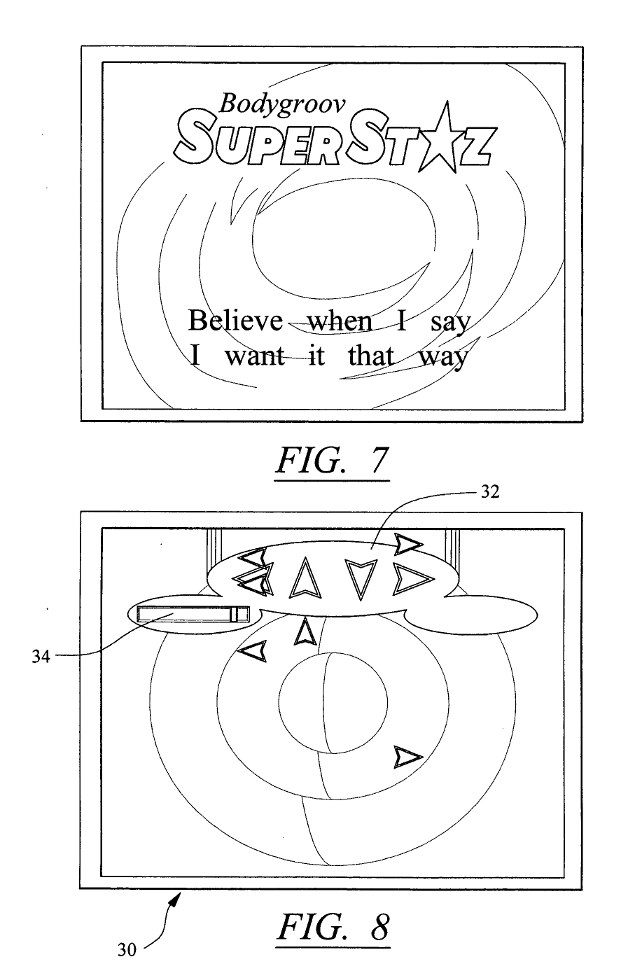

The words of the song are displayed by central processing unit 12 on display device 16, as shown in FIG. 7. The words may be displayed in multiple lines and scroll downwardly on display device 16. Entertainment device 10 indicates to a user when each word should be sung. In one embodiment, each word may be highlighted, displayed in a color that is different than the other words displayed on the screen, or otherwise brought to the attention of a user when that individual word or phrase should be sung. While a song is being displayed on display device 16, central processing unit 12 may play the background music for the song through speakers 23. The user may adjust the volume, pitch, and tempo of the song being played by using controls 25, which may be on input device 20 or on control processing unit 12. An additional input device 16, such as a microphone, may be coupled to central processing unit 12 so that another user may sing together with the first user to form a duet. After the song has been completed, central processing unit 12 may display mode selection screen 26.

B. Dance Mode

Entertainment device 10 may operate in dance mode where a user dances on mat 14 to a song selected by the user. A user may select a song from a list of songs. The central processing unit 12 plays the song, with or without lyrics. A user may also select the level of difficulty of the dance, such as easy, regular, or hard. Once the difficulty level has been selected, the user depresses the “start” button to play the selected song. While the song is being played, display device displays a screen, such as the dance screen 30 shown in FIG. 8. Dance screen 30 displays arrows in target box 32 pointing to the location that the user should place his or her feet on mat 14. The location for foot placement may be generated by the processor and may be based on a semi-random pattern generation along with some sampling or reference to the beat of the music being played. If the user correctly places his or her feet on the correct location on mat 14 and the timing is correct, the arrow on the screen may be highlighted, which signifies a correct step was made by the user.

Entertainment system 10 assigns points to the user that are recorded in what may be referred to as a “life meter” 34. The objective for the user is to step on the correct footprint 24 located on mat 14 that corresponds with the arrow that is shown in target box 32. The amount of points are tracked and displayed on display device 16. When the user misses an arrow, points are subtracted from life meter 34. When life meter 34 falls to zero, the game is over. The display device 16 may display the word “failed” on the screen. Display device 16 may display the percentage of correct dance steps made, the highest score obtained by any user, and other information. After a few moments, display device 16 will display song selection screen 28.

The “life meter” 34 or other display may also display a bar graph to show the range that the user has available in order to continue to the next level of difficulty, or speed, in the dance program. For example, if the user gets less than 50% of the dance steps correct during a first song, the playback may stop and the system may display a results screen showing the percentage correct. The system may give the user a chance to repeat the same song or quit to the main menu. If the user gets more than 50% of the dance steps correct during the first song, a screen may be displayed between songs to indicate the score, and the system may continue automatically to the next song. If the user continues to get more than 50% of the dance steps correct, or 50%+(10% * the difficulty level number), the system may continue playing songs from its memory or a playlist selected by the user. Otherwise, the system may “fail” the user at a particular level. The user may be given a score, that may be based on the percentage of correct steps, that may increase with each level correctly danced, so that a user can try to beat their previous best score each time they play the system.

C. Karaoke and Dance Combination Mode

Entertainment device 10 may include a karaoke and dance combination mode. After a user has chosen the karaoke and dance combination mode icon from mode selection screen 26, song selection screen 28 is displayed. A user may select one or more songs to be played in successive order. Once a user has finished selecting the one or more songs, the user may actuate a “start” button 50. Display device 16 then may give the user the ability to choose the difficulty level of the song and dance, such as, easy, regular, and hard. The user can then actuate the “start” button 50, which will cause the central processing unit 12 begin playing the song. While the song is being played, display device 16 will display the words to the song, as described above for the karaoke mode, and will display target box 32 for guiding the user through the proper dance steps. The user may adjust parameters, such as volume, pitch, an tempo of the song being played. If the user losses all of his or her points target box will stop displaying arrows, but entertainment device 10 will continue to display the words to the song until the song has been completed. At the conclusion of the song, the user's percentage of correct dance steps are displayed. The display device 16 then displays mode selection screen 26.

D. Competition Mode

Entertainment device 10 may include a competition mode enabling two or more users to compete against each other, and may allow the users to select a dance competition, a karaoke competition or a dance and karaoke competition. For the entertainment device 10 to operate in dance competition mode, the central processing units 12 of two mats 14 should be place in communication with each other. In one embodiment, this may be accomplished using a challenge wire. The challenge wire may be formed from an insulated conductive wire having connectors at each end that are capable of being coupled to mats 14. A memory device 18 needs to be placed in only one of the central processing units 12. The power may be turned on when desired, and the first user can select the difficulty level, which may be, but is not limited to, easy, regular, or difficult. The first user may then press the “start” button to start the competition.

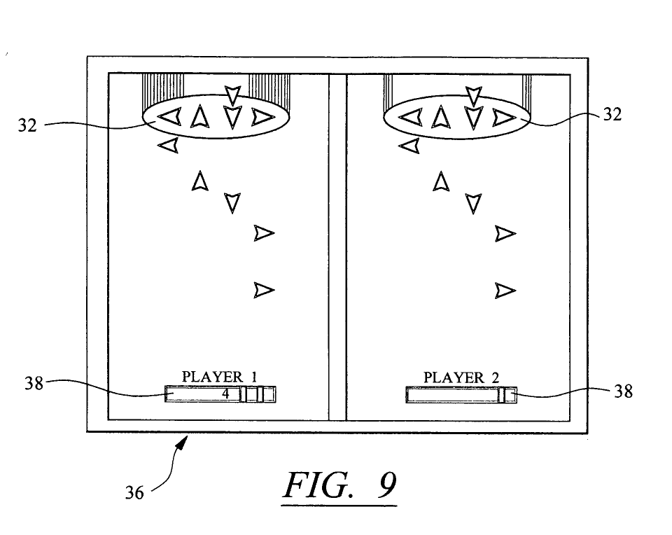

The competition mode screen 36, as shown in FIG. 9, is displayed, which may include a life meter 34 for each user, a scoring box 38 for each user, and a target box 32 for each user. Competition mode screen 36 may be divided vertically in the middle of the screen, whereby a first user's statistics may be displayed on one side of the screen and a second user's statistics may be displayed on another side of the screen. The users dance in the same manner as described above for the dance mode by following the arrows displayed in target box 32. The score for each user is displayed in the scoring boxes 38. If one of the users' score falls to zero while a song is being played, that user's game is ended and a word, such as “failed,” appears on the screen. The other user is able to continue dancing until the song has ended. At the end of the song, the users' statistics may be briefly displayed on the screen, and the “winner” may be displayed. The mode selection screen 26 may be displayed by a user depressing a “main menu” button.

The foregoing is provided for purposes of illustrating, explaining, and describing embodiments of this invention. Modifications and adaptations to these embodiments will be apparent to those skilled in the art and may be made without departing from the scope or spirit of this invention.

1. An entertainment device, comprising:
a central processing unit;
a mat coupled to the central processing unit and having one or more sensors coupled to the mat for teaching a user dance steps by receiving input from a user and transferring the input to the central processing unit;
a display device coupled to the central processing unit enabling the user to interact with the central processing unit and for displaying song lyrics for the user;
a memory device for storing programs;
at least one speaker for playing one or more songs;
at least one input device coupled to the central processing unit enabling the user to communicate with the central processing unit, wherein the input device includes at least one microphone enabling the user to reproduce the song lyrics displayed on the display device; and
a mode selector for various modes of the entertainment device, the modes including a karaoke mode, a dance mode and a combination karaoke and dance mode.

2. The entertainment device of claim 1, wherein the display device is a monitor.

3. The entertainment device of claim 1, wherein the display device is a television.

4. The entertainment device of claim 1, wherein the memory device is selected from the group consisting of a removable cartridge and a CDG system.

5. The entertainment device of claim 1, wherein the at least one input device comprises two microphones.

6. The entertainment device of claim 1, wherein the at least one microphone includes controls for controlling operation of the entertainment device.

7. The entertainment device of claim 6, wherein the controls are selected from the group consisting of an on/off switch, a mode select switch, a volume switch, and an echo switch.

8. The entertainment device of claim 1, wherein the at least one input device communicates with the central processing unit using wireless communication technology.

9. The entertainment device of claim 1, wherein the at least one input device is coupled to the central processing unit using electrical wires.

10. The entertainment device of claim 1, wherein the mat comprises four or more sensors coupled to the mat for receiving input from a user.

11. The entertainment device of claim 10, wherein the sensors are positioned on the mat in a cross formation.

12. The entertainment device of claim 1, wherein the mat includes a foot actuated on/off switch embedded in the mat.

13. The entertainment device of claim 1, further comprising at least one connector for coupling the central processing unit of the entertainment device to a second entertainment device.

14. The entertainment device of claim 1, wherein the modes include a competition mode.
